(19) United States
(12) Patent Application Publication
(10) Pub. No.: US 2004/0201819 A1
(43) Pub. Date: Oct. 14, 2004

(54) Sportnoculars

(76) Inventors: Kennety Guy, Ukiah, CA (US); Christine Risch, Redwood Valley, CA (US)

Correspondence Address: Kenneth W. Guy, c/o 5529 N. Old Settlers Rd., Morgantown, IN, 46160, US

(21) Appl. No.: 10/409,494

(22) Filed: Apr. 9, 2003

(51) Int. Cl. G02C 7/08

(52) U.S. Cl. 351/57

(57) ABSTRACT

The invention is the design of creation, which incases 2 optic lenses that have an adjuster to view the sporting event at the best possible. The idea is to be able to have hands free viewing of an event watching any type of show or event. The concept is for the user to be able to see the action from a distance with total hands free movement. The thoughts creating the idea are some of the people using hands one type of viewing using their hands to hold the view object. The invention is of such a nature that the user can have either type of optic lenses in the choice of sportnoculars depending on the sight of the individual.

### CROSS-REFERENCES TO RELATED APPLICATIONS

U.S. Pat. No. 6,493,136 B2 Byung Jin Changand Thomas A. Cummings=in reference to clip on version, U.S. Pat. No. 5,880,805 Jan Naessens and Edwin Thys.

Sportnoculars are for the spectators who enjoy having hands free to watch the game and be able to have hands free to do what they want with. The spectator can also view the sporting event easier by the sportnoculars by the means of not having to hold anything up to their eyes.

Not sponsored by any business, government, corporation, and company only by inventors.

### BACKGROUND OF THE INVENTION

Christine and I thought of the invention idea while at sporting events and concerts. We thought how nice it would be to watch and view the sporting action with out having to hold the binoculars with one or both hands. We started to put prototypes together to see what we could produce something light yet able to be user friendly. Christine and I came up with three versions of the concept.

### FIELD OF THE INVENTION

The uses of the invention are numerous as the invention can be used indoors and out doors. The invention will help the user to see the event from a distance better than with out having the invention. For example the user can view any sporting event from the stand of a rodeo seat to and seat in an air show at an airport. The user could view a football game outside or a basketball game inside. We could see virtually any sporting action from skiing to auto racing

“The related art” is the clipping device where the spring action of the clip and the clipping on to prescription eyewear is used the relation is the clip on and the action of the spring. The related art is background art but not infringed for the invention of sportnoculars. The version I have is able to adjust down for the viewing adjustment.

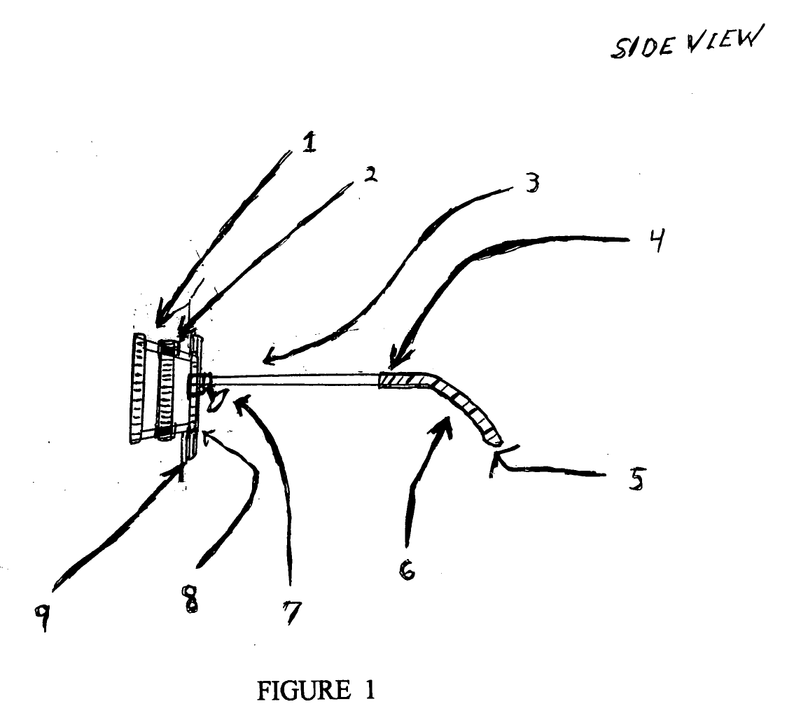

FIG. 1 Description: Side view of Sport-oculars showing how they would appear looking from side. Note: this is the version for the people not using prescription eye wear.

Part # 1, plastic part that encases the outer optic lenses. Note this part is from mold injection that holds on the outer lenses.

Part # 2, the adjusting dial that is one part that the incased outer lenses are in and the outer part no. 1 holds. This part also adjusts on part no. 8.

Part # 3, this is the part between the two circled frames called the bridge area which can be bent to allow for adjustment from a narrow person to a larger cranium person.

Part # 4, This is the rail from the eye area to the ear area; on this part it can also be adjusted for a good fit to the user as it can be made of soft metals.

Part # 5, This is the plastic mold over the ear part of or soft plastic allowing for the user to have the string attachment sliding over and around the neck to avoid the breakage of the sport-oculars. This area can also be bent to fit the user.

Part # 6 this area is in the manufacturing process where I choose to have it metal or hard plastic this is because foam will not allow the user to have the neck lace or rope to hold their sport-oculars where as the hard plastic ear area would. I am going with hard plastic.

Part # 7, nosepiece—plastic attached to the wire that is attached to the frame bridge, which allows for adjustment.

Part # 8, the inter part of sport-oculars which incases the smaller optic lenses. This part is made of plastic mold injection.

Part # 9, this is the metal frame around the part no#8 that incases the smaller diameter optic lenses.

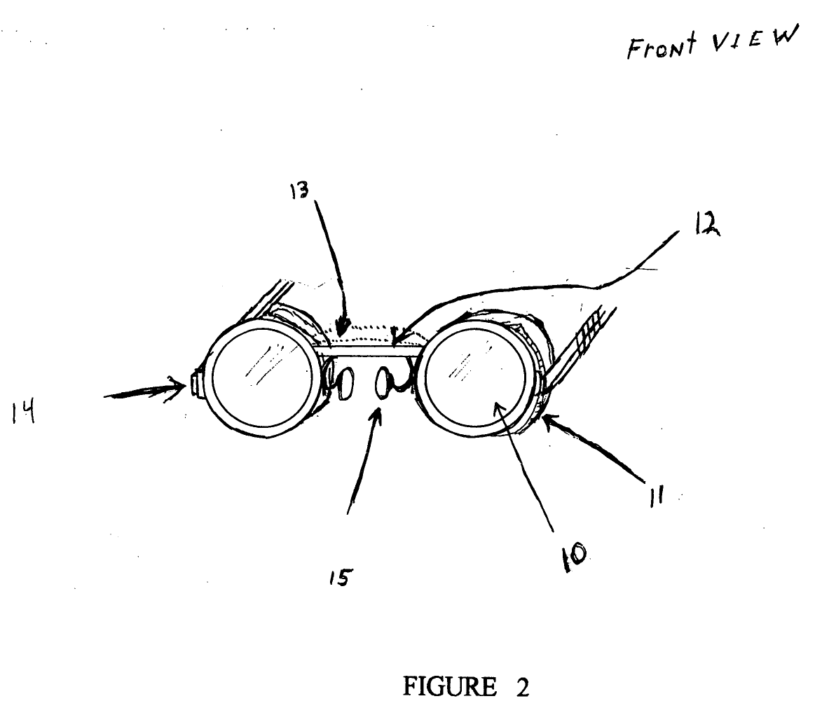

FIG. 2, Description, Front view of the model type that is all frame showing the Sport-oculars incased in the frames. Note: this is eyewear for a person with out prescription glasses.

Part # 10 the front optic lenses 1.5 in. to 3 cm. In diameter. Two types one is power 24 and one is power 30.

Part # 1, the adjuster dial for the sight viewing.

Part # 12, the bridge that is metal and bendable to fit and adjust to the consumer.

Part # 13, showing the wire from the bridge going to the nose pad. This is adjustable for the user consumer.

Part # 14, showing the side attaching rail bar to the frame, which is around the housing of the optics. Note: this is an area that is fitted together not folding at all. If there were a folding part it would be in the rail from the optic to the ear curve.

Part # 15, this is the nose pad, which is made of plastic secured to the wire metal mounted to the bridge.

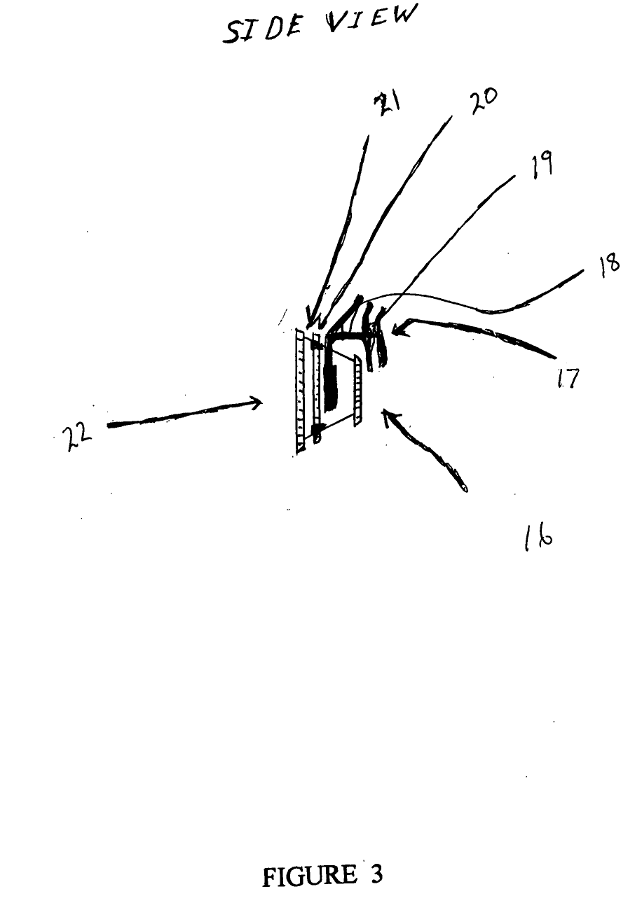

FIG. 3 Description, This is a side view of the clip on version of Sport-oculars.

Part # 16, this is the inter housing of the smaller optic in which comes in two strengths one is power 9 and the other is power 12. This part is made of plastic and is a mold injection process.

Part # 17, this is the clip on rear holding plastic part made of plastic or light metal.

Part # 18, this is the frame that can be made of metal or hard plastic. This part holds the housing of the optic lenses on the out side of the housing.

Part # 19, This is the spring that forces the smaller clip to hold to the frame of the glasses that it gets attached to via the frame of the attachment called Sport-oculars.

Part # 20, this is the dial that is part of the plastic itself that is molded. This is where the adjustment for viewing is dialed. This means in the mold injection process this is in the die cast up to the incasing of the glass housing the lenses.

Part # 21, this is the outer plastic part that holds the lenses in place. Note: in a more expensive model this part could screw on and off to allow for changing lenses.

Part # 22, this is the outer lenses which is 1.5 in. to 3 cm in dial. With the power of 24 in one model and the power of 30 in the other model.

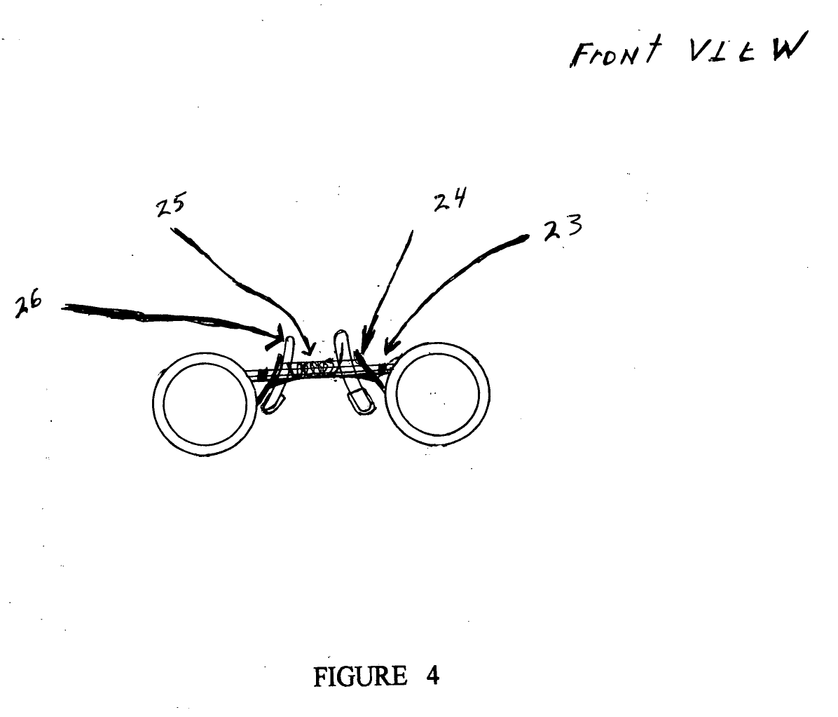

FIG. 4 Description, This is the front view of the clip on version of the Sport-oculars.

Part # 23, This is showing the bridge and how it can be adjusted in and out by a incased tube when made accordingly, The more inexpensive way of manufacturing the product would entail bending the bridge outside of the middle area Note: this would be done with delicate tools.

Part # 24, this is the inter support from the bridge to the housing incasing the lenses.

Part # 25, this is showing the spring area where there are two springs for the best support

Part # 26, this is the handle part where the user puts their fingers to clip the sport-oculars on their glasses. The bottom of this part comes with foam over the ends to allow for maximum grip to the eyewear. This part also is holding the spring encasing it to the frame.

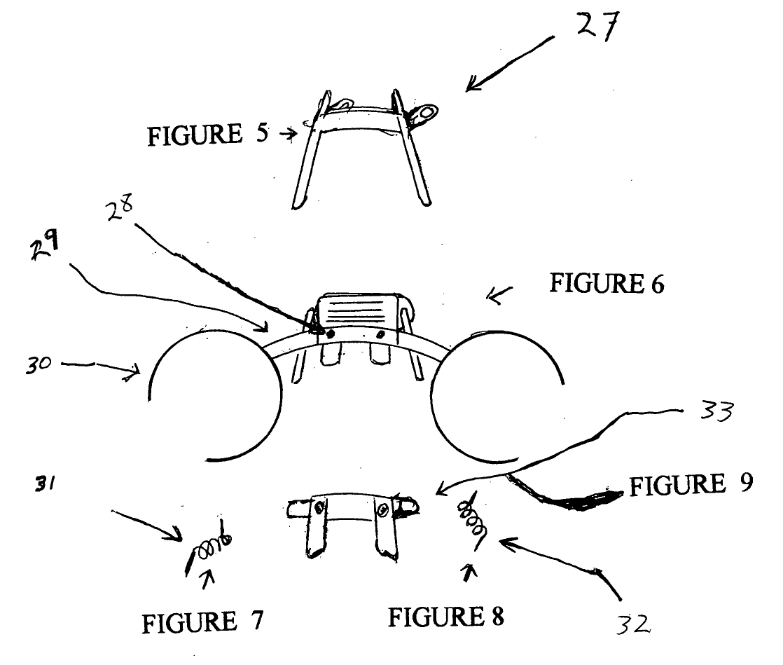

FIG. 5, description, this shows clip on piece with the holes in it that the spring force to hold to what ever it clips to.

Part # 27, this is the clip that the springs hold against and goes over the part no 28 allowing the clip to hold to the glasses it gets attached to.

FIG. 6, Description, Front view of the frame clip on version.

Part # 28, the screw that holds the clip on assembly to the bridge. There are two screws.

Part # 29, The Bridge is made of bendable metal and comes in different colors.

Part # 30, Frame enclosing around the housing of the lenses.

FIG. 7 Description, view of the spring

Part # 31, small springs less than one-pound test. Two ear type with ¼ in levers

FIG. 8, description, View of spring.

Part # 32, Small spring less than one-pound test, two-ear type with ¼ in levers.

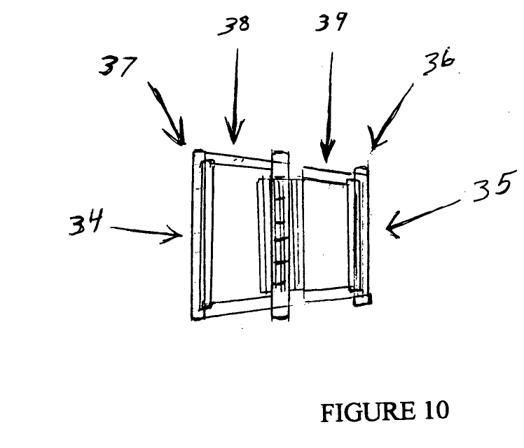

FIG. 9, Description, clip axel and bracket piece.

Part # 33, This is the part that make the clip work the axel and screw in to the bridge frame part the springs go around the ends and lever to the frame and the clip.

FIG. 10, Description, This is the side view of the housing. The housing assembled is two parts one screwing on to the other allowing for adjustment. The male part of the housing is 3 parts one the housing then the lenses then the holding outer cover, which is glued in place. The female part is the adjusting part allowing for sight adjustment incasing the outer lenses with an outer cover holding it in place with glue or epoxy. Note; this can come in colors of various types.

Part # 34, this the outer lenses which there are two strengths power 24 and power 30 and is 2 cm. To 3 cm. In diameter.

Part # 35, this is the inner lenses of which comes in two powers, power 9 and power 12. This is 1 cm. To 1.5 cm. In diameter.

Part # 36, this is the cover holding the lenses to the housing it is epoxy together.

Part # 37, this is the outer cover holding the outer lenses in place in the housing, it also is glued in place.

Part # 38, this is the outer housing grooved on the outer edge to allow for the lenses to fit in perfect place.

Part # 39, This is the male housing which has male thread which allows the female counter part to adjust for viewing. The male housing is also grooved in the area to allow for the fitting of the lenses.

1. I, Kenneth Guy claim that the Idea and invention named “Sport-oculars” can be manufactured with the materials of light metals and plastics.
I, Kenneth Guy claim that the Idea and invention called “Sport-oculars” has two versions one is whole eye wear incased in frames resting on the ears and nose, and the other version clipping on the prescription glasses or sunglasses.
I Kenneth Guy claim that the invention and Idea called “sport-oculars” optic viewing can be made with glass or plastic and comes in two Power strengths Optic lenses 12×30 and 16×32.
